(19) United States
(12) Patent Application Publication
(10) Pub. No.: US 2022/0363137 A1
(43) Pub. Date: Nov. 17, 2022

(54) SYSTEM FOR WIRELESS POWER TRANSFER TO A MOBILE ROBOT

(71) Applicant: NextFirst Engineering Technologies Private Limited, Bengaluru (IN)

(72) Inventors: Jayendran BALASUBRAMANIAN, Bengaluru (IN); Steven Charles NEEBE, Mountain View, CA (US)

(21) Appl. No.: 17/317,590

(22) Filed: May 11, 2021

(51) Int. Cl. B60L 9/24; H02J 50/10; H02J 50/40; B60L 53/12; B60L 53/62

(52) U.S. Cl. CPC B60L 9/24; H02J 50/10; H02J 50/40; B60L 53/12; B60L 53/62

(57) ABSTRACT

A system for wireless power transfer to a mobile robot is presented. The system includes one or more mobile robots including a permanent magnet and at least one pair of receiving coils. The system further includes a magnetic track including a plurality of transmitting coils configured to receive power from a power supply. The system further includes a control system configured to control the power transmitted from the power supply to the plurality of transmitting coils. The control system is further configured to selectively control the plurality of transmitting coils to: simultaneously provide propulsion to a mobile robot of the one or more mobile robots moving along the magnetic track and wirelessly transfer power to the mobile robot, or switch from providing propulsion to a mobile robot of the one or more mobile robots moving along the magnetic track to wirelessly transferring power to the mobile robot.

### BACKGROUND

Embodiments of the description generally relate to systems for wireless power transfer to a mobile robot, and more particularly to systems for wireless power transfer to a mobile robot in a material handling system.

There are a variety of automated material handling systems currently used in material storage and delivery environments (such as a warehouse). Mobile robotic systems are one such example of automated material handling systems. Mobile robotic systems typically include electric devices/actuators that require an energy source for operation.

One solution for providing energy to a mobile robot is to provide a dedicated location along the track at which the energy is supplied. The mobile robot stops at the dedicated location where a temporary connection to an energy source may be established. This process, however, requires the mobile robot to come to a stop at the dedicated location, wait for power to be connected, and wait for the power to be disconnected before resuming motion. The additional steps required to supply power reduce the throughput of the system and the dedicated locations limit the ability of actuators on a mobile robot to operate. Further, such a solution is only able to transfer power to the mobile robot in a static state and not when the robot is in motion, i.e., in a dynamic state.

Another solution for providing energy to a mobile robot is to provide a fixed connection to the mobile robot. The fixed connection may be, for example, an electrical conductor or a charging station where the mobile robot may be plugged in. However, with an electrical conductor, the motion of the mobile robot is typically restricted to limit the required length of the electrical conductor. On the other hand, independent charging stations typically require additional hardware that may wear out over time and scale linearly with the number of robots. Further, independent charging stations are only able to transfer power to the mobile robot in a static state and not when the robot is in motion, i.e., in a dynamic state.

Therefore, there is a need for systems capable of transferring power without a fixed connection to a mobile robot, both in a static state as well as a dynamic state.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a system for wireless power transfer to a mobile robot is presented. The system includes one or more mobile robots; wherein each mobile robot of the one or more mobile robots includes a permanent magnet and at least one pair of receiving coils. The system further includes a magnetic track configured to allow movement of the one or more mobile robots across its path, the magnetic track includes a plurality of transmitting coils configured to receive power from a power supply. The system further includes a control system configured to control the power transmitted from the power supply to the plurality of transmitting coils. The control system is further configured to selectively control the plurality of transmitting coils to: simultaneously provide propulsion to a mobile robot of the one or more mobile robots moving along the magnetic track and wirelessly transfer power to the mobile robot, or switch from providing propulsion to a mobile robot of the one or more mobile robots moving along the magnetic track to wirelessly transferring power to the mobile robot.

According to another example embodiment, a system for wireless power transfer to a mobile robot in a material handling system is presented. The system includes one or more mobile robots including at least one electrical device. Each mobile robot of the one or more mobile robots includes a permanent magnet and at least one pair of receiving coils. The system further includes a transport system including a plurality of magnetic tracks. Each magnetic track of the plurality of magnetic tracks is configured to allow movement of the one or more mobile robots across its path. Further, each magnetic track of the plurality of magnetic tracks includes a plurality of transmitting coils. The system further includes a power supply configured to provide power to the plurality of transmitting coils. The system furthermore includes a control system configured to control the power transmitted from the power supply to the plurality of transmitting coils. The control system is further configured to selectively control the plurality of transmitting coils to simultaneously provide propulsion to a mobile robot of the one or more mobile robots moving along the magnetic track and also wirelessly transfer power to the mobile robot to power the at least one electrical device, or switch from providing propulsion to a mobile robot of the one or more mobile robots moving along the magnetic track to wirelessly transferring power to the mobile robot to power the at least one electrical device.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram of a system for wireless power transfer to a mobile robot, according to some aspects of the present description,

FIG. 2A is a top view of a mobile robot configuration, according to some aspects of the present description,

FIG. 2B is a front view of a mobile robot configuration, according to some aspects of the present description,

FIG. 2C is a top view of a mobile robot configuration, according to some aspects of the present description,

FIG. 2D is a front view of a mobile robot configuration, according to some aspects of the present description,

FIG. 3A is a side view of a mobile robot configuration, according to some aspects of the present description,

FIG. 3B is a side view of a mobile robot configuration, according to some aspects of the present description, and

FIG. 4 is a block diagram of a system for wireless power transfer to a mobile robot, according to some aspects of the present description.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Example embodiments of the present description present systems for wireless power transfer to a mobile robot, and more particularly systems for wireless power transfer to a mobile robot in a material handling system.

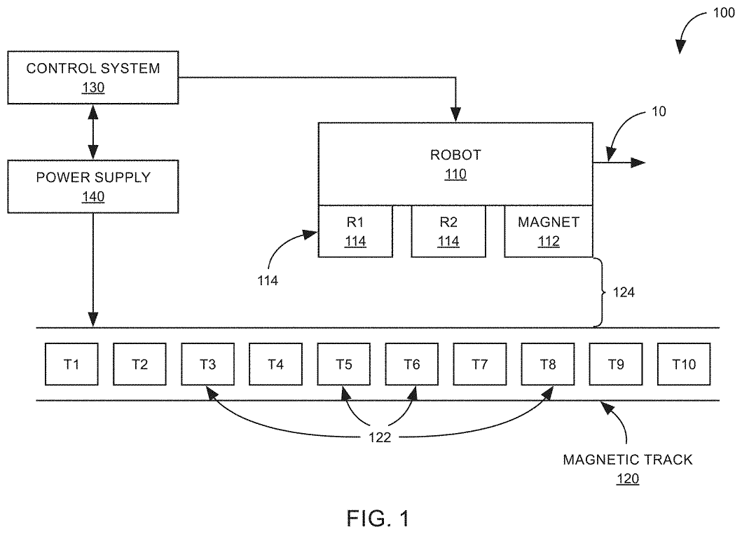

FIG. 1 is a block diagram of an example system 100 for wireless power transfer to a mobile robot. The system 100 includes one or more mobile robots 110, a magnetic track 120, a control system 130, and a power supply 140. The magnetic track 120 is configured to allow movement of the one or more mobile robots 110 across its path. The control system 130 is configured to control the power transmitted from the power supply 140 to the magnetic track 120. Each of these components is described more in detail later.

The term “mobile robot” as used herein refers to a robotic device or a vehicle that is capable of movement. Further, the term “mobile robot” as used herein includes automatic guided vehicles (AGVs). It should be noted that only one mobile robot 110 is shown in FIG. 1 for illustration purposes, and a plurality of mobile robots are also envisaged within the scope of the present description. The number of mobile robots would depend on the end-use requirement. The terms “mobile robot” and “one or more mobile robots” are used herein interchangeably.

In some embodiments, the mobile robot 110 is a material-handling robot, an inspection robot, or a repair robot. In some embodiments, the mobile robot 110 is a vehicle that provides for the movement of material along the magnetic track 120. The mobile robot 110 in some such instances may be further configured to pick up the material e.g., from storage or pick-up locations in a warehouse context or other processing sites in a manufacturing context. In some embodiments, the mobile robot 110 may include powered rollers e.g., in applications involving individual items rather than cases. In some embodiments, the mobile robot 110 may further include robotic arms. In some embodiments, the mobile robot 110 may include cross-belts and/or forks for handling totes/cases, e.g., in applications involving where the material needs to be put away. These could be storage/delivery locations or other feeder systems feeding downstream processes/storage.

In some embodiments, the mobile robot 110 is configured for inspection and/or for troubleshooting, e.g., in manufacturing sites. In some embodiments, the mobile robot 110 is configured for error recovery, and for rectifying the error before recommencing operation e.g., in manufacturing sites. In certain embodiments, the mobile robot 110 is configured to provide for the movement of material (as individual items, totes, or cases).

The mobile robot 110 according to embodiments of the present disclosure includes a magnetic portion on at least a portion of its base that allows for the movement of the mobile robot on the magnetic track 120. In some embodiments, each mobile robot of the one or more mobile robots 110 includes a permanent magnet for the movement of the mobile robot on the magnetic track 120.

As shown in FIG. 1, the mobile robot 110 includes a permanent magnet 112 mounted to a surface of the mobile robot 110 such that when the mobile robot 110 travels across the magnetic track 120, the permanent magnet 112 faces the plurality of transmitting coils 122 extending along the magnetic track 120. Further, as shown in FIG. 1, the permanent magnet 112 is mounted on the mobile robot 110 such that the permanent magnet 112 is spaced apart from the transmitting coils 122 and an air gap 124 is provided between the permanent magnet 112 and the magnetic coils 122.

In some embodiments, the permanent magnet 112 may include a plurality of magnets segments (not shown in FIGs.) arranged in an array and mounted on the surface of the mobile robot 110. The separate magnet segments may alternately have a north pole, N, and a south pole, S, pole facing the magnetic track 120. Two adjacent magnet segments including a north pole and a south pole may be considered a pole-pair in such instances.

The mobile robot 110, further includes at least one pair of receiving coils 114 for receiving wireless power from the magnetic track 120, as described in detail later. In some embodiments, a plurality of windings in the coils of the at least one pair of receiving coils 114 are oriented in opposite directions to offset any induced motion generated by the plurality of transmitting coils 122 during the wireless power transfer to the mobile robot 110.

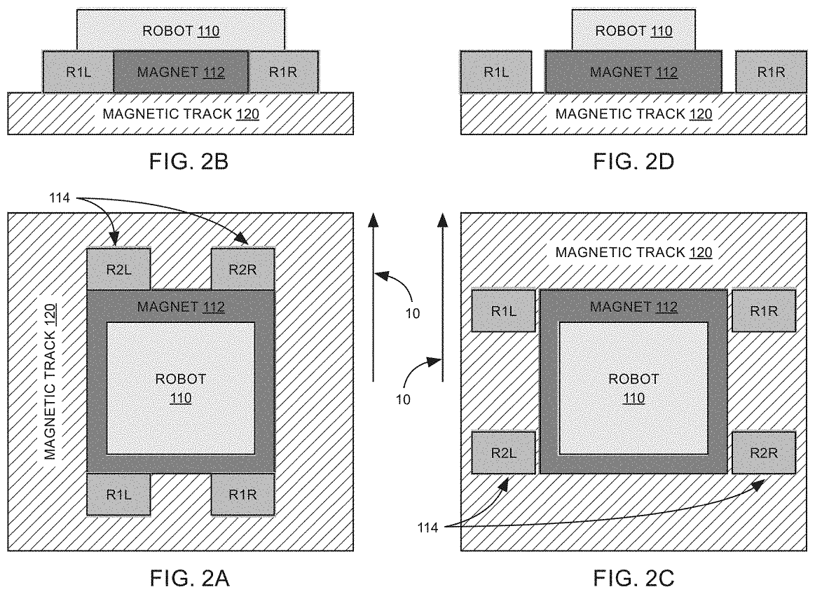

In some embodiments, the at least one pair of receiving coils 114 are mounted on the mobile robot 120 in a direction substantially parallel to the movement of the mobile robot 110 across the magnetic track 120. FIG. 2A shows a top view of a mobile robot 120 having two pairs of receiving coils 114 mounted on the mobile robot 120 in a direction substantially parallel to the movement of the mobile robot 110 (as shown by arrow 10) across the magnetic track 120. As shown in FIG. 2A, the mobile robot 120 includes R1L and R1R (first pair) and R2L and R2R (second pair) of receiving coils mounted in a direction substantially parallel to the direction of travel. It should be noted that R1L and R1R are shown as being mounted on the opposite sides of the mobile robot 110 for illustration purposes only. The receiving coils may be mounted on the same side of the magnet 112 and adjacent to each other as well. Similarly. R2L and R2R may be mounted on the same side of the magnet 112 and adjacent to each other as well. FIG. 2B shows the front view of the configuration shown in FIG. 2A.

In some embodiments, the at least one pair of receiving coils 114 are mounted on the mobile robot 120 in a direction substantially lateral to the movement of the mobile robot 110 across the magnetic track 120. FIG. 2C shows a top view of a mobile robot 120 having two pairs of receiving coils 114 mounted on the mobile robot 120 in a direction substantially lateral to the movement of the mobile robot 110 (as shown by arrow 10) across the magnetic track 120. As shown in FIG. 2C, the mobile robot 120 includes R1L and R1R (first pair) and R2L and R2R (second pair) of receiving coils mounted in a direction substantially lateral to the direction of travel. It should be noted that R1L and R1R are shown as being mounted on the opposite sides of the robot 110 for illustration purposes only. The receiving coils may be mounted on the same side of the magnet 112 and adjacent to each other as well. Similarly. R2L and R2R may be mounted on the same side of the magnet 112 and adjacent to each other as well. FIG. 2D shows the front view of the configuration shown in FIG. 2C.

The system 100 further includes a magnetic track 120 configured to allow movement of the mobile robot 110 in at least one direction in the xy-plane. In some embodiments, the system 100 may include a plurality of magnetic tracks arranged in the xy plane to allow movement of the one or more mobile robots 110. Depending on the orientation of the magnetic track 120, the magnetic track 120 includes a plurality of linear electromagnetic motors arranged longitudinally in the x-direction or the y-direction. In some embodiments, the magnetic track 120 may include a plurality linear electromagnetic motor blocks arranged longitudinally in the magnetic track. These blocks of linear electromagnetic motors, arranged longitudinally, act as tracks for the mobile robot 110 to travel in forward/backward directions. As noted earlier, the plurality of linear electromagnetic motor blocks includes a plurality of magnetic coils that provide for propulsion of the one or mobile robots 110.

In some embodiments, the magnetic track 120 includes a plurality of transmitting coils 122 as shown in FIG. 1. The plurality of transmitting coils 122 is spaced parallelly along each track segment of the magnetic track 120. In some embodiments, the plurality of transmitting coils 122 may be mounted in a channel extending longitudinally along one surface of a track segment of the magnetic track 120. As described in detail later, an electromagnetic field generated by a transmitting coil 122 spans the air gap 124 and interacts with the permanent magnet 112 mounted to the mobile robot 110 to control the movement of the mobile robot 110.

The system 100 further includes a control system 130 and a power supply 140. The control system 130 is configured to control the power transmitted from the power supply to the plurality of transmitting coils 122. The control system 130 is configured to control an alternating current (AC) transmitted by the power supply 140 to the plurality of transmitting coils 122 along the magnetic track 120 to provide for the propulsion of the mobile robot 110.

The transmitting coils 122 are sequentially energized by the transmitted AC power, thereby establishing an electromagnetic field around the coils. The electromagnetic field interacts with the magnetic field generated by the pole pairs on the permanent magnet 112 and is controlled to provide propulsion and movement to the mobile robot 110 along the magnetic track 120. In some embodiments, the control system 130 may be configured to control the AC power transmitted by the power supply 140 to the plurality of transmitting coils 122 when the permanent magnet 112 is proximate to the transmitting coils 122. This is further illustrated with reference to FIG. 1.

In the embodiment illustrated in FIG. 1, the control system 130 is configured to transmit a first AC power from the power supply 140 to a first selected transmitting coils (e.g., T7 and T8) of the plurality of transmitting coils 122 if the first selected transmitting coils are proximate to the permanent magnet 112 on the mobile robot 110, thereby providing propulsion to the mobile robot 110 while maintaining location.

The control system 130 is further configured to control the supply of power from the power supply 140 to the plurality of transmitting coils 122 such that power is wirelessly transferred from the plurality of transmitting coils 122 to the at least one pair of receiving coils 114 on the mobile robot 110.

In one embodiment, the control system 130 is configured to selectively control the plurality of transmitting coils 122 to simultaneously provide propulsion to a mobile robot of the one or more mobile robots 110 moving along the magnetic track 120 and wirelessly transfer power to the mobile robot 120. In another embodiment, the control system 130 is configured to selectively control the plurality of transmitting coils 122 to switch from providing propulsion to a mobile robot of the one or more mobile robots 110 moving along the magnetic track 120 to wirelessly transferring power to the mobile robot 110.

The wireless power, according to embodiments of the present description, may be transferred for both static and dynamic states of the mobile robot 110. In the static state, the mobile robot 110 is stationary during the wireless power transfer step, whereas in the dynamic state, the mobile robot 110 is in motion during the wireless power transfer step. In both embodiments, the same coils that are used to provide propulsion to the mobile robot 110 may also be employed for wirelessly transferring power to the mobile robot 110.

In some embodiments, the control system 130 is configured to switch to transmitting a second AC power from the power supply to a selected set of transmitting coils if the selected set of transmitting coils are proximate to the at least one pair of receiving coils 114 such that power is wirelessly transferred to the at least one pair of receiving coils 114. In such instances, the first AC power has the frequency and other characteristics optimally tuned for propulsion and the second AC power has the frequency and other characteristics tuned for power transmission.

According to embodiments of the present description, the receiving coils 114 may be configured such that they do not have any effect on the propulsion forces. In some embodiments, the receiver coils 114 are operated in pairs such that the forces between the receiving coils 114 and transmitting coils 122 are in opposite direction within the pair. Further, as mentioned earlier, a plurality of windings in the coils of the at least one pair of receiving coils 114 may be oriented in opposite directions to offset any induced motion generated by the plurality of transmitting coils 122 during wireless power transfer to the mobile robot 110.

Referring again to FIG. 1, when the permanent magnet 112 is proximate to the transmitting coils T5 and T6, the control system 130 may be configured to send a signal to the power supply 140 to transmit AC power to T5 and T6 with characteristics tuned for propulsion. After the mobile robot 110 has moved such that the receiving coils R1 and R2 are proximate to the transmitting coils T5 and T6, the control system 130 may be configured to send a signal to the power supply 140 to transmit AC power to T5 and T6 with characteristics tuned for power transfer. Thus, the same coils that are used for propulsion may be used for power transfer.

Similarly, when the permanent magnet 112 is proximate to transmitting coils T7 and T8, the control system 130 may be configured to send a signal to the power supply 140 to transmit AC power to T7 and T8 with characteristics tuned for propulsion. Once the mobile root 110 has moved such that the receiving coils R1 and R2 are proximate to the transmitting coils T7 and T8, the control system 130 may be configured to send a signal to the power supply 140 to transmit AC power to T7 and T8 with characteristics tuned for power transfer.

Thus, power is transferred to the mobile robot 110 while the mobile robot 110 is moving along the magnetic track 120. In some other embodiments, power may be transferred to the mobile robot 110 when the mobile robot 110 is stationary. Referring again to FIG. 1, in such instances, once the mobile robot 110 has reached a static state, the control system 130 may be configured to send a signal to the power supply 140 to transmit AC power to T5 and T6 with characteristics tuned for power transfer.

In some embodiments, the control system 130 is configured to transmit the first AC power from the power supply to the selected set of transmitting coils of the plurality of transmitting coils 122 such power is wirelessly transferred to the at least one pair of receiving coils 114 while simultaneously providing propulsion. In some such embodiments, the first AC power may include an AC sine wave carrying a primary propulsion signal along with a secondary power transfer signal of a different frequency. The receiving coils 114 in such instances are configured to receive the secondary AC frequency. In some other embodiments, the first AC power may include a primary propulsion signal having harmonics, and the receiving coils in such instances are configured to receive the harmonics.

Referring again to FIG. 1, the control system 130 may be configured to send a signal to the power supply 140 to transmit AC power to the transmitting coils T5, T6, T7, and T8 such that the AC signal can simultaneously provide propulsion to the mobile robot 120 as well as wirelessly transfer power to the mobile robot 110. In such an instance, the magnetic field generated between the transmitting coils T7 and T8 and the permanent magnet 112 provides for propulsion while the receiving coils R1 and R2 are configured to receive the power from the transmitting coils T5 and T6.

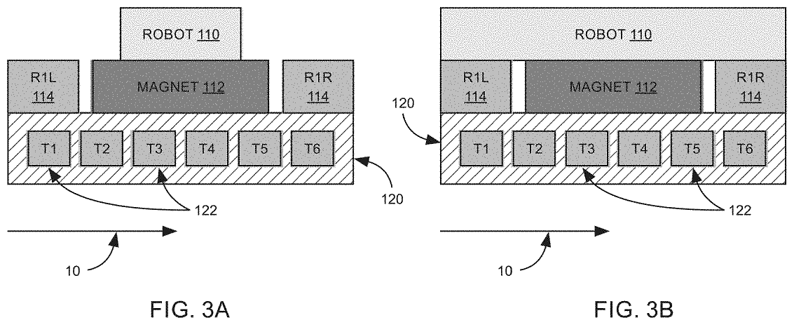

FIGS. 3A and 3B show the side view of configurations shown in FIGS. 2A and 2C, respectively. FIG. 3A illustrates the configuration corresponding to the receiving coils 114 being mounted parallelly to the direction of travel, while FIG. 3B illustrates the configuration corresponding to the receiving coils 114 being mounted laterally to the direction of travel. In FIGS. 3A and 3B, the control system 130 may be configured to send a signal to the power supply 140 to provide power AC power to the transmitting coils 122 such that they switch from propulsion to power transfer, or simultaneously provide propulsion and power transfer, as described earlier with reference to FIG. 1.

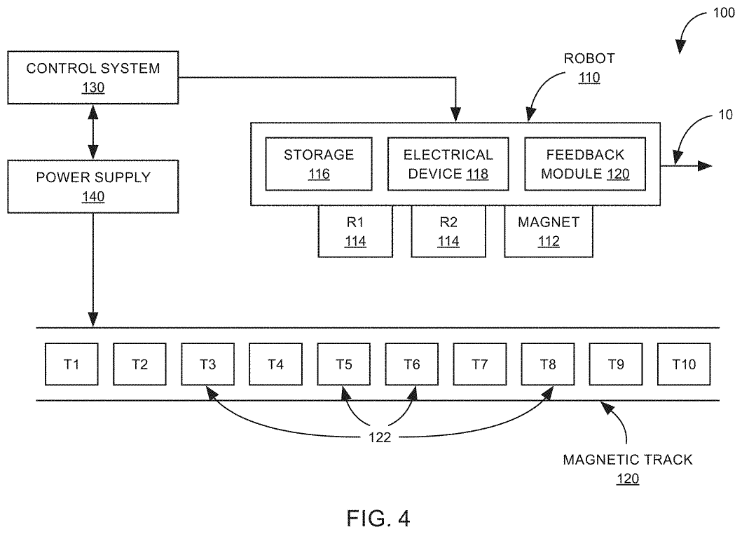

The mobile robot 110 may further include a storage element configured to store at least a portion of power wirelessly transferred by the plurality of transmitting coils 122. FIG. 4 illustrates a mobile robot 110 including a storage element 116. The storage element 116 may include a battery capable of storing at least some of the transferred power.

The mobile robot may further include at least one electrical device 118, as shown in FIG. 4. In some embodiments, the least one electrical device 118 may be an actuator configured to transfer material to and from the mobile robot to a location in a material handling system. Non-limiting examples of the at least one electrical device include powered rollers, robotic arms, cross-belts, forks, and the like.

The mobile robot 110 may further include a feedback module 120, as shown in FIG. 4. The feedback module 120 is communicatively coupled to the control system and configured to provide data regarding the mobile robot 110 to the control system 130. The control system 120 controls the power transmitted from the power supply 140 to the transmitting coils 122 for wireless power transfer, based on the data provided.

In some embodiments, the data provided by the feedback module 120 to the control system 130 may include a position of the mobile robot 110, the permanent magnet 112, and/or the receiving coils 114. The position of the permanent magnet 112 and/or the receiving coils vis-à-vis the transmitting coils 122 may be used by the control system 130 to determine when the transmitting coils 122 need to be switched from propulsion to power transfer, as described in detail earlier. Further, the position of the permanent magnet 112, and/or the receiving coils may be used by the control system to identify the selected set of transmitting coils.

In some embodiments, the data provided by the feedback module 120 to the control system 130 may include whether power is being transferred to the mobile robot and an amount of power transferred. Based on the amount of power required vis-à-vis the amount of power received, the control system 130 may be configured to regulate the voltage of the power transfer signal to ensure optimal power transfer.

The system 100, as described herein, may be implemented in any site/location that requires an automated system for material handling, inspection, and/or error recovery. In some embodiments, the system 100 may be implemented in storage sites, delivery sites, manufacturing sites, and the like. In certain embodiments, the system 100 is implemented in a material and delivery system (e.g., a warehouse).

A system for wireless power transfer to a mobile robot in a material handling system is also presented. The system includes one or more mobile robots including at least one electrical device. Each mobile robot of the one or more mobile robots includes a permanent magnet and at least one pair of receiving coils. The system further includes a transport system including a plurality of magnetic tracks including. Each magnetic track of the plurality of magnetic tracks is configured to allow movement of the one or more mobile robots across its path. Further, each magnetic track of the plurality of magnetic tracks includes a plurality of transmitting coils. The system further includes a power supply configured to provide power to the plurality of transmitting coils. The system furthermore includes a control system configured to control the power transmitted from the power supply to the plurality of transmitting coils. The control system is further configured to selectively control the plurality of transmitting coils to simultaneously provide propulsion to a mobile robot of the one or more mobile robots moving along the magnetic track and also wirelessly transfer power to the mobile robot to power the at least one electrical device, or switch from providing propulsion to a mobile robot of the one or more mobile robots moving along the magnetic track to wirelessly transferring power to the mobile robot to power the at least one electrical device.

Systems of the present description enable wireless power transfer to a mobile robot both in a static as well as a dynamic state. Thus, maximizing the utilization (movement) of the mobile robots and enabling them for additional application functions. Systems of the present description further provide for wireless power transfer to mobile robots using existing infrastructure such as transmitting coils already mounted in magnetic tracks, thereby reducing infrastructure costs. Moreover, the systems of the present description minimize the need for an additional power distribution network, which would require add additional maintenance and support costs that scale linearly with the size of the system. Further, the power transmitted can also be varied based on the number of receiving coils added to the mobile robots in modular blocks, which would otherwise require higher power distribution systems.

While only certain features of several embodiments have been illustrated, and described herein, many modifications and changes will occur to those skilled in the art. It is, therefore, to be understood that the appended claims are intended to cover all such modifications and changes as fall within the scope of the invention and the appended claims.

1. A system for wireless power transfer to a mobile robot, comprising:
one or more mobile robots; wherein each mobile robot of the one or more mobile robots comprises a permanent magnet and at least one pair of receiving coils;
a magnetic track configured to allow movement of the one or more mobile robots across its path, the magnetic track comprising a plurality of transmitting coils configured to receive power from a power supply; and
a control system configured to control the power transmitted from the power supply to the plurality of transmitting coils and selectively control the plurality of transmitting coils to:
simultaneously provide propulsion to a mobile robot of the one or more mobile robots moving along the magnetic track and wirelessly transfer power to the mobile robot, or
switch from providing propulsion to a mobile robot of the one or more mobile robots moving along the magnetic track to wirelessly transferring power to the mobile robot.

2. The system of claim 1, wherein a plurality of windings in the coils of the at least one pair of receiving coils are oriented in opposite directions to offset any induced motion generated by the plurality of transmitting coils during wireless power transfer to the mobile robot.

3. The system of claim 1, wherein the at least one pair of receiving coils are mounted on the mobile robot in a direction substantially parallel to the movement of the mobile robot across the magnetic track.

4. The system of claim 1, wherein the at least one pair of receiving coils are mounted on the mobile robot in a direction substantially lateral to the movement of the mobile robot across the magnetic track.

5. The system of claim 1, wherein the control system is configured to transmit a first AC power from the power supply to a selected set of transmitting coils of the plurality of transmitting coils if the selected set of transmitting coils are proximate to a permanent magnet on the mobile robot, thereby providing propulsion to the mobile robot while maintaining location.

6. The system of claim 5, wherein the control system is further configured to switch to transmitting a second AC power from the power supply to the selected set of transmitting coils if the selected set of transmitting coils are proximate to the at least one pair of receiving coils such that power is wirelessly transferred to the at least one pair of receiving coils.

7. The system of claim 5, wherein the control system is configured to transmit the first AC power from the power supply to the selected set of transmitting coils of the plurality of transmitting coils such that power is wirelessly transferred to the at least one pair of receiving coils while simultaneously providing propulsion.

8. The system of claim 1, wherein the mobile robot comprises a storage element configured to store at least a portion of power wirelessly transferred by the plurality of transmitting coils.

9. The system of claim 1, wherein the mobile robot further comprises a feedback module communicatively coupled to the control system and configured to provide data regarding the mobile robot to the control system, wherein the control system controls the power transmitted from the power supply to the transmitting coils for wireless power transfer, based on the data provided.

10. The system of claim 9, where the data comprises one or more of: a position of the one or more mobile robot, a position of the permanent magnet, a position of the at least one pair of receiving coils, or an amount of power being transferred to the one or more mobile robot.

11. A system for wireless power transfer to a mobile robot in a material handling system, comprising:
one or more mobile robots comprising at least one electrical device, wherein each mobile robot of the one or more mobile robots comprises a permanent magnet and at least one pair of receiving coils;
a transport system comprising a plurality of magnetic tracks, each magnetic track of the plurality of magnetic tracks configured to allow movement of the one or more mobile robots across its path, and comprising a plurality of transmitting coils;
a power supply configured to provide power to the plurality of transmitting coils; and
a control system configured to control the power transmitted from the power supply to the plurality of transmitting coils and selectively control the plurality of transmitting coils to:
simultaneously provide propulsion to a mobile robot of the one or more mobile robots moving along the magnetic track and also wirelessly transfer power to the mobile robot to power the at least one electrical device, or
switch from providing propulsion to a mobile robot of the one or more mobile robots moving along the magnetic track to wirelessly transferring power to the mobile robot to power the at least one electrical device.

12. The system of claim 11, wherein the plurality of windings in the coils of the at least one pair of receiving coils are oriented in opposite directions to offset any induced motion generated by the plurality of transmitting coils during wireless power transfer to the mobile robot.

13. The system of claim 11, wherein the at least one pair of receiving coils are mounted on the mobile robot in a direction substantially parallel to the movement of the mobile robot across the magnetic track.

14. The system of claim 11, wherein the at least one pair of receiving coils are mounted on the mobile robot in a direction substantially lateral to the movement of the mobile robot across the magnetic track.

15. The system of claim 11, wherein the control system is configured to transmit a first AC power from the power supply to a selected set of transmitting coils of the plurality of transmitting coils if the selected set of transmitting coils are proximate to a permanent magnet on the mobile robot, thereby providing propulsion to the mobile robot while maintaining location.

16. The system of claim 15, wherein the control system is further configured to switch to transmitting a second AC power from the power supply to the selected set of transmitting coils if the selected set of transmitting coils are proximate to the at least one pair of receiving coils such that power is wirelessly transferred to the at least one pair of receiving coils.

17. The system of claim 15, wherein the control system is configured to transmit the first AC power from the power supply to the selected set of transmitting coils of the plurality of transmitting coils such that power is wirelessly transferred to the at least one pair of receiving coils while simultaneously providing propulsion.

18. The system of claim 11, wherein the at least one electrical device is configured to transfer material to and from the mobile robot to a location in a material handling and storage system.

19. The system of claim 11, wherein the mobile robot comprises a storage element configured to store at least a portion of power wirelessly transferred by the plurality of transmitting coils.

20. The system of claim 11, wherein the mobile robot further comprises a feedback module communicatively coupled to the control system and configured to provide data regarding the mobile robot to the control system, wherein the control system controls the power transmitted from the power supply to the transmitting coils for wireless power transfer, based on the data provided.
